(19) United States
(12) Patent Application Publication
(10) Pub. No.: US 2024/0150169 A1
(43) Pub. Date: May 9, 2024

(54) ELECTROLYSIS AND PYROLYTIC NATURAL GAS CONVERSION SYSTEMS FOR HYDROGEN AND LIQUID FUEL PRODUCTION

(71) Applicant: InEnTec Inc., Richland, WA (US)

(72) Inventors: Daniel R. Cohn, Cambridge, MA (US); Leslie Bromberg, Sharon, MA (US); Jeffrey E. Surma, Richland, WA (US)

(73) Assignee: InEnTec Inc., Richland, WA (US)

(21) Appl. No.: 18/548,541

(22) PCT Filed: Mar. 2, 2022
(86) PCT No.: PCT/US2022/018571

§ 371 Date: Aug. 31, 2023

Related U.S. Application Data
(60) Provisional application No. 63/156,268, filed on Mar. 3, 2021.

(51) Int. Cl. C01B 3/24; C01B 3/12; C01B 32/40; C01B 32/50

(52) U.S. Cl. CPC C01B 3/24; C01B 3/12; C01B 32/40; C01B 32/50; C01B 2203/0255; C01B 2203/0272; C01B 2203/0283; C01B 2203/0822; C01B 2203/0838; C01B 2203/085; C01B 2203/0855; C01B 2203/0861; C01B 2203/1241

(57) ABSTRACT

Embodiments of the invention relate to systems and methods for producing hydrogen gas and liquid fuels from methane-containing gases or organic feedstock using one or more of pyrolysis or electrolysis. The systems and methods include using gasifiers, oxidation units, cleaners, and liquid fuel manufacturing systems to produce liquid fuels. Ratios of carbon to hydrogen are controlled in the systems and methods to provide efficient liquid fuel and hydrogen formation.

### CROSS-REFERENCE TO RELATED APPLICATIONS

This application claims the filing benefit of U.S. Provisional Application No. 63/156,268, filed Mar. 3, 2021, which is incorporated herein in its entirety by this reference for any and all purposes.

### BACKGROUND

Pyrolytic conversion of natural gas and renewable natural gas to hydrogen can potentially provide a large source of low-carbon hydrogen at a relatively low cost. This hydrogen could be used for low carbon electricity generation and other applications. Pyrolysis converts methane into hydrogen and elemental carbon. The hydrogen and elemental carbon are typically utilized as products. Elemental carbon is often discarded as a waste product.

### SUMMARY

Embodiments of the invention relate to systems and methods that utilize one or both of a pyrolyzer or an electrolyzer to produce hydrogen gas and carbon products, such as elemental carbon, carbon monoxide, or carbon dioxide for producing liquid fuel products.

In an embodiment, a system for producing hydrogen and carbon monoxide is disclosed. The system includes a pyrolyzer operably coupled to a feed supply of a methane-containing gas, wherein the pyrolyzer is configured to convert methane from the methane-containing gas into hydrogen and elemental carbon via pyrolysis. The system includes an electrolyzer configured to produce hydrogen and oxygen. The system includes an oxidation unit configured to produce one or more of carbon monoxide or carbon dioxide from the elemental carbon produced from the pyrolyzer and the oxygen produced from the electrolyzer.

In an embodiment, a liquid fuel manufacturing system is disclosed. The system includes an electrolyzer configured to produce hydrogen and oxygen. The system includes a gasifier configured to produce carbon monoxide, hydrogen, and water from an organic feedstock and oxygen from the electrolyzer. The system includes a cleaner configured to separate water from the carbon monoxide and hydrogen produced in the gasifier. The system includes a liquid fuel manufacturing system configured to produce a liquid fuel using carbon monoxide from the cleaner and hydrogen from the electrolyzer.

In an embodiment, a liquid fuel manufacturing system is disclosed. The system includes a pyrolyzer operably coupled to a feed supply of a methane-containing gas, wherein the pyrolyzer is configured to convert methane from the methane-containing gas into hydrogen and elemental carbon via pyrolysis. The system includes an electrolyzer configured to produce hydrogen and oxygen. The system includes an oxidation unit operably coupled to an oxygen output of the electrolyzer and an elemental carbon output of the pyrolyzer, the oxidation unit being configured to at least partially oxidize the elemental carbon from the pyrolyzer with the oxygen from the electrolyzer to produce carbon monoxide. The system includes a liquid fuel manufacturing system configured to produce a liquid fuel using carbon monoxide from the oxidation unit and hydrogen from the electrolyzer.

In an embodiment, a method for producing hydrogen, carbon monoxide, and carbon dioxide is disclosed. The method includes pyrolyzing a methane-containing gas to produce hydrogen and elemental carbon from pyrolysis. The method includes electrolyzing water to produce hydrogen gas and oxygen from electrolysis. The method includes oxidizing the elemental carbon using the oxygen from the electrolyzer, carbon dioxide, or a combination thereof to produce carbon dioxide.

In an embodiment, a method for producing hydrogen, elemental carbon, carbon monoxide, and electricity is disclosed. The method includes electrolyzing water to produce hydrogen gas and oxygen from electrolysis. The method includes pyrolyzing a methane-containing gas in the presence of oxygen from electrolysis to produce hydrogen, elemental carbon, and carbon monoxide from pyrolysis. The method includes performing a water-gas shift reaction with the hydrogen and carbon monoxide from pyrolysis to produce hydrogen gas and carbon dioxide. The method includes oxidizing the hydrogen gas from the water-gas shift reaction in a gas engine to produce electricity.

In an embodiment, a method for producing hydrogen and liquid fuel is disclosed. The method includes electrolyzing water to produce hydrogen gas and oxygen from electrolysis. The method includes pyrolyzing a methane-containing gas to produce hydrogen and elemental carbon from pyrolysis. The method includes oxidizing the elemental carbon from pyrolysis with oxygen from electrolysis to produce carbon monoxide. The method includes creating a liquid fuel or chemical using carbon monoxide and hydrogen gas.

In an embodiment, a method for producing hydrogen and liquid fuel is disclosed. The method includes electrolyzing water to produce hydrogen gas and oxygen from electrolysis. The method includes gasifying an organic feedstock in the presence of oxygen from electrolysis to produce carbon monoxide and water from gasification. The method includes separating the carbon monoxide from the water. The method includes creating a liquid fuel using carbon monoxide and hydrogen gas.

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

The drawings illustrate several embodiments of the invention, wherein identical reference numerals refer to identical or similar elements or features in different views or embodiments shown in the drawings.

FIG. 1A is a block diagram of a system for producing hydrogen gas and carbon dioxide, according to an embodiment.

FIG. 1B is a block diagram of a system for producing hydrogen gas and carbon dioxide, according to an embodiment.

FIG. 2 is a block diagram of a system for producing liquid fuel products, according to an embodiment.

FIG. 3 is a block diagram of a system for producing liquid fuel products, according to an embodiment.

FIG. 4 is a block diagram of a system for producing liquid fuel products, according to an embodiment.

FIG. 5 is a block diagram of system for producing liquid fuel products, according to an embodiment.

FIG. 6 is a block diagram of a system for producing liquid fuel products, according to an embodiment.

### DETAILED DESCRIPTION

Embodiments of the invention relate to systems and methods that utilize one or both of pyrolyzers or electrolyzers to produce hydrogen gas and carbon products, such as elemental carbon, carbon monoxide, or carbon dioxide for producing liquid fuel products. The pyrolyzer uses methane-containing gas to produce hydrogen and elemental carbon. The electrolyzer provides oxygen for pyrolyzer operation as well as producing very pure hydrogen. The oxygen can be viewed as a zero to low cost product that becomes available from the electrolyzer production of high value pure hydrogen.

The use of the oxygen provides a synergistic effect with pyrolyzer operation by providing heating for the pyrolyzer, such as via oxidation (e.g., combustion), and by producing carbon monoxide (CO) which can be used to produce additional hydrogen. One use of the hydrogen-rich gas from the pyrolyzer is for electricity production from a gas turbine or reciprocating engine. Another use of the hydrogen-rich gas is to improve the hydrogen gas to carbon monoxide ratio in a gasifier that converts various hydrocarbon feedstocks into syngas that is used to produce liquid fuels. Systems and methods disclosed herein can use electrolyzers alone to increase syngas gas-based production. Systems and methods disclosed herein can use pyrolyzers alone to for conversion of methane to a liquid fuel.

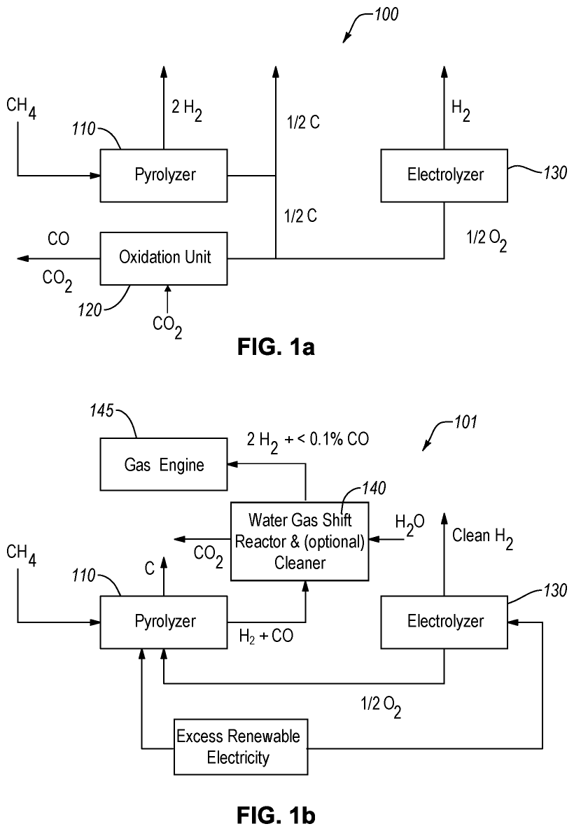

FIG. 1A is a block diagram of a system 100 for producing hydrogen gas and carbon dioxide, according to an embodiment. The system 100 includes a pyrolyzer 110, an oxidation unit 120 fluidly connected to the pyrolyzer 110, and an electrolyzer 130 fluidly connected to the oxidation unit 120. The pyrolyzer 110 is fluidly connected to a methane or natural gas source on a feed or input side thereof. The pyrolyzer 110 may include any pyrolysis unit such as a reaction chamber connected to one or more heat sources to heat the reaction chamber to a temperature above a decomposition temperature of methane. The reaction chamber may be an oxygen free environment or oxygen may be introduced therein in a controlled amount. The pyrolyzer 110 may use at least one of electrical heating, which can be provided by one or more of inductive heating, microwave heating, or plasma heating; combustion heating, which can be provided by use of the oxygen from the electrolyzer 130; or a heated bath, such as molten salt pyrolysis system that includes a reaction chamber heated by molten salt. For example, the pyrolyzer 110 may include the reaction chamber that is heated by one or more of microwave heating, joule heating, plasma heating, inductive heating, or combustion heating. The pyrolyzer 110 includes a hydrogen gas (H₂) output and a carbon output on a product side.

In the pyrolyzer 110, a methane-containing gas, such as natural gas, landfill gas, or the like is pyrolyzed to hydrogen gas and carbon (e.g., elemental carbon) products. The hydrogen is exported out of the system 100 as a product gas and the carbon may be exported out of the system 100 as a product or further processed in the system 100 to create further products (e.g., CO, CO₂, or both).

The electrolyzer 130 may be operably coupled to an input source for inputting water or another material for electrolyzing to component products. For example, water may be electrolyzed in the electrolyzer to form a hydrogen gas product and oxygen gas for use in oxidation (e.g., combustion). The electrolyzer 130 may include any electrolyzer equipped to electrolyze water into hydrogen and oxygen such as including an anode, a cathode, and an electrolyte. Suitable electrolyzers 130 may include a polymer electrolyte membrane electrolyzer, an alkaline electrolyzer, or the like. The input side of the electrolyzer 130 may be connected to a water supply, such as a tank, water line, or the like. A product side of the electrolyzer 130 may be fluidly connected to an output for hydrogen gas produced in the electrolyzer 130 and an output for oxygen gas produced in the electrolyzer 130. The output for oxygen gas may be fluidly connected to the oxidation unit 120, such as at the oxidation unit 120 or joined with the carbon output from the pyrolyzer 110 prior to the oxidation unit 120.

The oxidation unit 120 receives the carbon from the pyrolyzer 110 and oxygen gas, such as from the electrolyzer 130 to produce carbon dioxide. The oxidation unit 120 may include a reaction chamber and a heat source to heat reactants in the reaction chamber to at least partially oxidize carbon or other materials. The oxidation unit 120 may include one or more inlets for reactants such as carbon, carbon dioxide, or oxygen. The oxidation unit 120 may include a combustor or a gasifier in some examples. The oxidation unit 120 may include a combustion system suitable for combusting elemental carbon. The oxidation unit 120 may include a Direct Carbon Fuel Cell (DCFC). The oxygen is used to oxidize or combust some of the elemental carbon generated in the pyrolyzer and produces an essentially pure CO₂ stream, which can be sequestered or used as an input for producing liquid fuel. The oxidation unit 120 generates heat that can be used for directly driving the pyrolysis reaction (through a heat exchanger), and/or it can be used to generated electricity (for example, by using a boiler with a steam turbine). In such examples, the oxidation unit 120 is operably coupled to one or more of a heat exchanger in thermal communication with the pyrolyzer 110 to at least partially heat the methane-containing gas that is generated therein or to a boiler connected to a steam turbine to create electricity using the heat from the combustion of elemental carbon. The electricity can be used to complement surplus renewable electricity to drive either the electrolyzer 130 or the pyrolyzer 110. The electricity that is generated from the oxidation unit 120 can be used to provide heating for the pyrolyzer 110. A gas engine (e.g., reciprocating engine or gas turbine) could alternatively be used as the oxidation unit 120 where the gas engine could provide both heat and electricity for the pyrolyzer 110. Accordingly, the pyrolyzer(s) 110 and pyrolysis processes carried out therein can be driven by a combination of combustion heating and selective electrically driven heating from one or more of inductive heating, microwave heating, or plasma heating. The electrolyzer 130 and pyrolyzer 110 can be driven, at least in part, by renewable electricity from an outside source (e.g., solar, wind, geothermal, hydroelectric).

The system 100 may be controlled to balance the amount of carbon produced from pyrolysis and the amount of oxygen produced from electrolysis to output a substantially pure CO₂ product (e.g., greater than 90% or greater than 95% CO₂). The ratio of electrolysis generated hydrogen (and oxygen) to hydrogen generated from pyrolysis of methane-containing gas such as natural gas or renewable natural gas (which mainly consists of methane) can be selectively controlled to provide the lowest total cost of hydrogen depending on factors that include the cost of renewable electricity that is used for electrolysis, the cost of natural gas (and/or renewable natural gas), the capital costs of the electrolyzer 130, the pyrolyzer 110 (e.g., pyrolytic conversion system), and the subsystem for converting the elemental carbon into heat, electricity, and relatively pure CO₂. The hydrogen from the pyrolyzer 110 and hydrogen from the electrolyzer 130 can be mixed together and sold for external use, such as for fuel. Alternatively, the two hydrogen streams can be sold for separate applications since the hydrogen from electrolysis is high purity hydrogen which is attractive for fuel cell use.

The elemental carbon produced in the pyrolyzer 110 can be more easily disposed of than CO₂ or converted into a pure CO stream for use in industrial processes. For example, elemental carbon may be directed to the oxidation unit 120 and carbon dioxide may be feed into the oxidation unit 120 to oxidize the elemental carbon to produce carbon monoxide product. Accordingly, the system 100 may be utilized to output one or both of carbon monoxide or carbon dioxide. In such examples, the oxidation unit 120 may be coupled to a carbon dioxide input instead of, or in addition to, an oxygen input to provide oxidizing gas into the reaction chamber of the oxidation unit 120.

While FIG. 1A is a block diagram of the system 100 for producing hydrogen and CO₂ for producing liquid fuel, FIG. 1A can be viewed as a method for producing hydrogen via both pyrolysis and electrolysis along with the use of oxygen from the electrolysis for producing CO₂. The CO₂ can be used for liquid fuel production. For example, pyrolysis of methane-containing gas may be carried out to produce hydrogen gas and elemental carbon. The elemental carbon can be oxidized (e.g., combusted) to produce CO₂. The system 100 and method shown in FIG. 1A makes use of the oxygen that is produced in the generation of hydrogen from electrolysis. Electrolysis may be carried out to produce oxygen gas for use in the oxidation reaction of the elemental carbon. The hydrogen from the pyrolysis and electrolysis may be output from the system individually, mixed and output, or used for heating for oxidation or pyrolysis. The feed and output rates of the pyrolysis and electrolysis may be selectively controlled to produce a selected ratio of elemental carbon and oxygen to produce carbon dioxide oxidation product with high purity carbon dioxide (e.g., less than 10% by weight carbon monoxide).

FIG. 1B is a block diagram of a system 101 for producing hydrogen gas and carbon dioxide, according to an embodiment. The system 101 includes a pyrolyzer 110, a water-gas shift reactor 140 fluidly connected to the pyrolyzer 110, an electrolyzer 130 fluidly connected to the pyrolyzer 110, and a gas engine 145 fluidly connected to the water-gas shift reactor 140. The pyrolyzer 110 is fluidly connected to a methane-containing gas source on a feed side thereof. The pyrolyzer 110 includes a hydrogen gas (H₂) output and a carbon output on a product side.

In the pyrolyzer 110, methane-containing gas is pyrolyzed to hydrogen gas and carbon (e.g., elemental carbon) products. The hydrogen is exported out of the system 100 as a product gas and the carbon may be exported out of the system 100 as a product or further processed in the system 100 to create further products (e.g., CO₂).

Water is electrolyzed in the electrolyzer 130 to form a hydrogen gas product and oxygen gas product. The input side of the electrolyzer 130 may be connected to a water supply, such as a tank, water line, or the like. A product side of the electrolyzer 130 may be fluidly connected to an output for hydrogen gas produced in the electrolyzer 130 and an output for oxygen gas produced in the electrolyzer 130. The output for oxygen gas may be fluidly connected to the pyrolyzer 110.

In the pyrolyzer 110, the methane-containing gas such as natural gas (CH₄) is heated in the presence of oxygen (from the electrolyzer) to produce elemental carbon, hydrogen gas, and carbon monoxide (CO). The elemental carbon may be output from the pyrolyzer 110 as a product while the hydrogen gas and carbon monoxide may be supplied to the water-gas shift reactor 140. One means of providing electricity for these heating technologies in the system 101 is by use of renewable electricity (e.g., solar, wind, hydroelectric, geothermal, or the like electricity) when available, by electricity from a grid, or by use of another source of electricity. The pyrolyzer 110 produces hydrogen, elemental carbon, and CO. The CO is converted into hydrogen and CO₂ by the water-gas shift reactor 140.

The water-gas shift reactor 140 may include high temperature water-gas shift units, low temperature water-gas shift units, or the like. For example, a high temperature water-gas shift reactor may be operated in a temperature range of about 550 to 900° F. and a low temperature water-gas shift reactor may be operated in a range of about 350 to 450° F. The water-gas shift reactor 140 may include a fixed bed reactor, a catalytic membrane reactor, or the like. The water-gas shift reactor 140 may be operably connected to the hydrogen gas and carbon monoxide output of the pyrolyzer 110. The water-gas shift reactor 140 may be operably connected to a water source (e.g., tank or water line). The water-gas shift reactor 140 includes an output for outputting CO₂ product as well as hydrogen gas as a product. The hydrogen gas produced from the water-gas shift reactor 140 may be substantially pure (e.g., includes less than 0.1% CO).

The water-gas shift reactor 140 may include, or be operably coupled to, an optional cleaner (e.g., clean-up unit) for separating components of the products of the water-gas shift reactor, namely hydrogen and carbon dioxide. The cleaner may include a pressure swing adsorption unit, an amine gas treatment unit, a membrane reactor, or the like for separating hydrogen from carbon dioxide.

The hydrogen-rich gas that is produced by a water-gas shift reactor 140 and optional cleaner can be stored for later use, such as in the gas engine 145 (e.g., turbine or reciprocating engine) or used directly by the gas engine 145. The gas engine 145 may include a gas turbine or reciprocating engine for electrical power generation, such as an engine of a generator. The gas engine 145 may power an electrical generator or a portion of the electrical power plant.

Gas turbine or reciprocating engine conversion of hydrogen into electricity does not require high purity hydrogen from a third party source in the system 101. By using the approach described in the system 101, pipeline gas (e.g., natural gas, pure methane, or the like) can be piped to the location of the gas engine 145 and converted into hydrogen-rich gas at the location using the system 101. The system 101 eliminates the need to transport hydrogen in pipelines or to use expensive vehicular or marine transport of hydrogen to operate the gas engine, such as to produce electricity with the gas engine 145. The elemental carbon that is produced at the location of the pyrolyzer unit and gas turbine or reciprocating engines can be either disposed of at this location or transported by truck, rail, or other means to a disposal site.

In some examples, the pyrolyzer 110 may be used without the electrolyzer 130, such as where oxygen is produced by an air separation unit instead of an electrolyzer.

The purity of the hydrogen determines the cleanup process downstream from the hydrogen generator (e.g., water-gas shift reactor 140, electrolyzer 130, pyrolyzer 110). In the case of the electrolyzer 130, the produced hydrogen purity is high, which is adequate for fuel cell applications. In the case of the pyrolyzer 110 or a gasifier, there can be levels of contaminants that would require cleanup, especially for fuel cell applications. If the hydrogen is used in a gas engine 145 (e.g., internal combustion engine or gas turbine), the limitation of the hydrogen purity may be relaxed. In principle, it is possible to use CO in the gas stream as a component of the fuel, as CO is a good fuel. Other impurities, such as sulfur, do not affect the combustion (although they may need to be controlled in the exhaust to meet pollution standards).

The level of CO produced in the water-gas shift reactor can vary. For example, the CO content in the producer gas can be selectively controlled (e.g., decreased) using high and low temperature water-gas shift reactors 140. CO content can be as low as 0.1%. This level of CO content in the hydrogen results in issues with safety. CO is safe at 50 ppm. The dilution for when the CO is hazardous (50 ppm) would have the hydrogen concentration at 5%, which is above the explosion limit for hydrogen. Thus, the safety of CO-hydrogen mixtures are not impacted when the CO concentration is low. A leak of hydrogen-CO will reach the hydrogen explosive limit before it reaches the CO safe levels.

The electricity from the gas engine can be exported for external use or, at times some of it can be used for providing electrical heating of the pyrolytic process.

The system 101 depicted in FIG. 1B assumes that all the oxygen that is produced from the electrolyzer 130 is consumed in steady state by the pyrolytic process in the pyrolyzer 110. However, the system 101 can also be operated without this constraint. One option is to store some or all of the oxygen produced in the electrolyzer 130 and to use it at a later time. For example, more oxygen could be used when less electricity is used. Another option is to use less oxygen overall and to produce more elemental carbon and less CO and CO₂ in the water-gas shift reactor 140. Use of a lower amount of oxygen could be obtained by a variety of means, including releasing some of the electrolyzer-produced oxygen to the atmosphere.

It can be attractive to only use a small amount of oxygen so that the pyrolyzer 110 is operating in close to a pyrolytic mode where only a small amount of partial oxidation of the carbon takes place. In such examples, the carbon to oxygen ratio in the pyrolyzer 110 should be greater than 2, such as 2-5, 5-10, 10-15, preferably greater than 5.

As an alternative to exporting the pure hydrogen stream from the electrolyzer 130 for higher value applications (e.g., for use in a fuel cell that requires pure hydrogen stream), some or all of the hydrogen from the electrolyzer 130 could at times be mixed with the hydrogen-rich gas from the pyrolyzer 110 to provide additional hydrogen rich gas that could be directly used in a gas engine 145 or stored for later use.

An alternative to providing the hydrogen-rich gas from the pyrolyzer 110 to the gas engine 145 is to provide the hydrogen-rich gas to a gasifier to increase the H₂ to CO ratio therein. For example, the ratio of H₂ to CO may be at least 1.8, such as or 1.8 to 5, 1.8 to 2.5, or 2.5 to 3.5. This approach is disclosed in relation to FIG. 5 below.

While FIG. 1B is a block diagram of the system 101 for producing hydrogen and CO₂, FIG. 1B can be viewed as a method for producing hydrogen via pyrolysis and electrolysis along with producing CO₂ for liquid fuel production. For example, pyrolysis of natural gas may be carried out to produce hydrogen gas, elemental carbon, and carbon monoxide. Electrolysis may be carried out to produce oxygen gas for use in the pyrolysis reaction. The hydrogen and carbon monoxide (e.g., syngas) from the pyrolysis may be output individually may be further processed in the water-gas shift reactor to produce carbon dioxide for liquid fuel production and hydrogen gas for use in a gas engine. The feed and output rates of the pyrolysis and electrolysis may be selectively controlled to produce a selected ratio of hydrogen to carbon monoxide product with high purity carbon dioxide (e.g., less than 10% by weight carbon monoxide) and hydrogen.

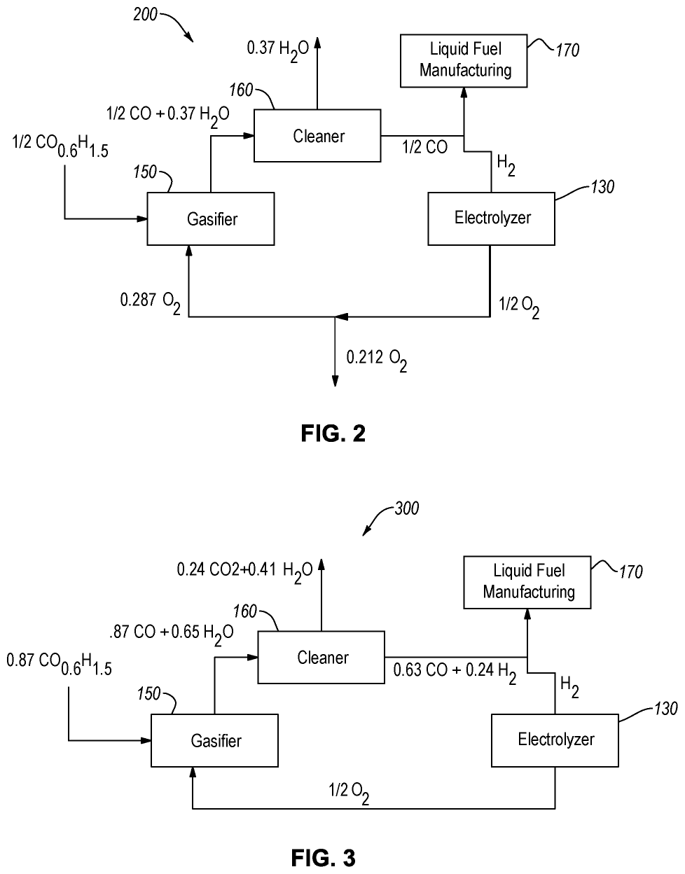

The processes depicted in FIGS. 1A and 1B can further include the use of a liquid fuel manufacturing system (e.g., reactor). The combination with a liquid fuel manufacturing system is disclosed below with respect to FIGS. 2-5. The liquid fuels that can be produced include methanol, ethanol, gasoline, and Fischer-Tropsch (FT) diesel. Both methanol and FT reactors utilize a hydrogen to CO concentration in the inlet of about 2:1 or higher. The hydrogen produced by an electrolyzer and/or a pyrolyzer can play an important role in providing the proper balance of hydrogen to CO in the liquid fuel manufacturing reactor.

FIG. 2 is a block diagram of a system 200 for producing liquid fuel products, according to an embodiment. The system 200 is a combined electrolyzer, gasifier, and liquid fuel manufacturing system where the liquid fuel manufacturing system uses the hydrogen the electrolyzer and carbon monoxide from the gasifier. The system 200 includes a gasifier 150, electrolyzer 130, a cleaner 160, and liquid fuel manufacturing system 170. The gasifier 150 is fluidly connected to a feedstock source (e.g., source of biomass, waste, natural gas, well gas, coal, oil, or other source of organic feedstock) as well as an oxygen source (e.g., electrolyzer 130) on an inlet or feed side thereof. The output (carbon monoxide and water) of the gasifier 150 is fluidly connected to the cleaner 160. The carbon monoxide output of the cleaner 160 is fluidly connected to the liquid fuel manufacturing system 170. The hydrogen output of the electrolyzer 130 is fluidly connected to the liquid fuel manufacturing system 170.

The electrolyzer 130 produces hydrogen gas and oxygen gas for later use in the system 200. The electrolyzer 130 is fluidly connected on a product side thereof to the liquid fuel manufacturing system 170 and the gasifier 150. The electrolyzer 130 outputs hydrogen gas to the liquid fuel manufacturing system 170 and oxygen to the gasifier 150. The oxygen may be fed to the gasifier 150 at a selected feed rate from an oxygen storage container fluidly connected to the electrolyzer 130 to create a selected ratio of oxygen to feedstock in the gasifier 150. The selected ratio of oxygen to feedstock entering the gasifier 150 provides a selected ratio of products produced in the gasifier 150 (e.g., carbon monoxide and water). For example, 0.287O₂ may be input into the gasifier 150 per ½CO_{0.6}H_{1.5}. In such examples, 0.212O₂ may be removed from the system 200, such as input into the atmosphere or stored in a storage tank.

The gasifier 150 may include any gasifier suitable to gasify organic feedstocks (e.g., municipal solid waste, agricultural waste, forestry waste, or any form of biomass) to form a product including a mixture of carbon monoxide and water. The gasifier 150 may include a reaction chamber and one or more heating sources therein. The one or more heating sources may include one or more of joule heating electrodes or elements, microwave emitters, plasma electrodes, or the like. The gasifier 150 may include an input side connected to a feed source. The feed into the gasifier 150 may include one or more of biomass, municipal waste, natural gas, well gas, or the like. The input side of the gasifier 150 may be connected to an oxygen source, such as the product side of the electrolyzer 130. For example, the oxygen may be fed into and used in gasifier 150, with biomass as a feedstock with an average composition of CO_{0.6}H_{1.5}. The gasifier 150 may convert substantially all the carbon in the feedstock (e.g., biomass) into CO and substantially all of the hydrogen in the feedstock into water. For example, the ½CO_{0.6}H_{1.5} is converted to 0.37H₂O in the gasifier 150.

The electrolyzer 130 and gasifier 150 (e.g., syngas production) shown in FIG. 2 ideally do not to generate any CO₂, or as little CO₂ as possible, and consume as much oxygen as possible. Not all the oxygen can be consumed, because it is limited by the hydrogen production in the electrolyzer 130. If all the oxygen is used in the gasifier 150, too much CO may be generated for use in the liquid fuel manufacturing system 170, which utilizes an H₂/CO ratio of at least 2:1 (e.g., 5:1 or more). In such a case, there is left over oxygen that needs to be either released or used elsewhere in the system 200. Such oxygen is may be stored and/or diverted from the system 200 in an oxygen storage container operably coupled to the electrolyzer 130 or removed from the system as a components of water in the cleaner 160.

The cleaner 160 conditions the producer gas so the appropriate hydrogen to carbon monoxide stoichiometry (e.g., 1.95:1-2.5:1) is reached for the liquid fuel manufacturing system 170. The cleaner may include a pressure swing adsorption unit, an amine gas treatment unit, a membrane reactor, or the like for separating hydrogen from carbon dioxide. The cleaner outputs substantially pure carbon monoxide to the liquid fuel manufacturing system 170 and also outputs water.

Hydrogen is provided by the electrolyzer 130 to the liquid fuel manufacturing system 170. Carbon monoxide is provided by the gasifier 150 (via the cleaner 160) to the liquid fuel manufacturing system 170. The liquid fuel manufacturing system 170 may include one or more of an FT reactor, a methanol reactor, ethanol reactor, higher alcohol reactor, dimethyl ether reactor, refining equipment (e.g., gasoline production systems), or the like. The liquid fuel manufacturing system 170 produces a liquid fuel which may be output for use or sale. The liquid fuel manufacturing system 170 may include a chemical manufacturing system for producing chemicals other than fuels.

While FIG. 2 is a block diagram of the system 200 for producing hydrogen and CO to produce liquid fuel, FIG. 2 can be viewed as a method for producing hydrogen via electrolysis along with producing CO from a gasifier for liquid fuel production. For example, gasification of feedstock may be carried out to produce carbon monoxide and water. Electrolysis may be carried out to produce oxygen gas for use in the gasifier. The carbon monoxide may be separated from other products of the gasifier, such as water, in the cleaner to feed substantially pure carbon monoxide to the liquid fuel manufacturing system 170. The hydrogen from electrolysis may be fed to the liquid fuel manufacturing system 170 to produce a liquid fuel or chemical.

The feed and output rates of the gasifier and electrolysis may be selectively controlled to produce a selected ratio of hydrogen to carbon monoxide product for producing a selected liquid fuel or chemical, such as methanol, ethanol, FT diesel, gasoline, or the like.

A system may be configured to create a mixture of hydrogen and carbon monoxide for the liquid fuel manufacturing system 170 with different ratio of hydrogen to carbon monoxide than is used in the system 200.

FIG. 3 is a block diagram of a system 300 for producing liquid fuel products, according to an embodiment. The system 300 is a combined electrolyzer, gasifier, and liquid fuel manufacturing system where the liquid fuel manufacturing system uses the hydrogen the electrolyzer and carbon monoxide (an hydrogen) from the gasifier. The system 300 includes gasifier 150, electrolyzer 130, cleaner 160, and liquid fuel manufacturing system 170. The gasifier 150 is fluidly connected to a feedstock source as well as an oxygen source (e.g., electrolyzer 130) on an inlet or feed side thereof. The output (carbon monoxide and water) of the gasifier 150 is fluidly connected to the cleaner 160. The carbon monoxide output of the cleaner 160 is fluidly connected to the liquid fuel manufacturing system 170. The hydrogen output of the electrolyzer 130 is fluidly connected to the liquid fuel manufacturing system 170.

While the system 300 is substantially identical to the system 200, the system 300 may be operated differently than the system 200. For example, the oxygen output of the electrolyzer 130 may be directly connected to the gasifier 150. In such examples, all the oxygen produced by the electrolyzer 130 may be consumed in the gasifier 150, and the composition of the produced gas may be adjusted (e.g., using a water-gas shift reaction) to increase the hydrogen to CO ratio to the level utilized by the liquid fuel manufacturing system. Some CO₂ produced is released with the excess water from the system 300. About 75% of the hydrogen used in the liquid fuel manufacturing system 170 comes from the electrolyzer 130 with the rest coming from the gasifier 150. The cleaner 160 may condition the producer gas so the appropriate hydrogen to carbon monoxide stoichiometry (1.95:1-2.5:1) is reached for the liquid fuel manufacturing system 170.

The systems depicted in FIGS. 2 and 3 provide an H₂/CO ratio of about 2:1, such as 1.5-2.5:1, 1.95:1-2.5:1, or 2.0-3.5:1. This ratio can be increased to a ratio of 2.2:1 or greater by reducing the amount of oxygen that is used. This may be attractive for some gasification applications.

The electrolyzer 130 may output one half of an O₂ molecule per H₂ molecule produced. The gasifier 150 receives the oxygen from the electrolyzer 130 along with 0.87CO_{0.6}H_{1.5} from the feed source. The gasifier 150 may output 0.87CO and 0.65H₂O. The gasifier 150 may output hydrogen as well. The cleaner 160 may receive the output of the gasifier 150 process the same to output 0.24CO₂ and 0.41H₂O outside of the system 300 along with 0.63CO and 0.24H₂ to the liquid fuel manufacturing system 170. One unit of H₂ from the electrolyzer 130 may be added to the liquid fuel manufacturing system 170 per 0.63CO and 0.24H₂ from the cleaner 160.

While FIG. 3 is a block diagram of the system 300 for producing hydrogen and CO, FIG. 3 can be viewed as a method for producing hydrogen via electrolysis along with producing CO from a gasifier for liquid fuel production. For example, gasification of feedstock may be carried out to produce carbon monoxide and water. Electrolysis may be carried out to produce oxygen gas for use in the gasifier. The carbon monoxide (and hydrogen) may be separated from other products of the gasifier, such as water, in the cleaner to feed carbon monoxide and hydrogen to the liquid fuel manufacturing system 170. The hydrogen from electrolysis (and the gasifier) may be fed to the liquid fuel manufacturing system 170.

Another approach to providing carbon monoxide and hydrogen for making liquid fuel, and making liquid fuel, is to use pyrolysis and an electrolyzer in combination with a liquid fuel manufacturing system that produces a liquid fuel from methane-containing gas, such as natural gas or renewable natural gas.

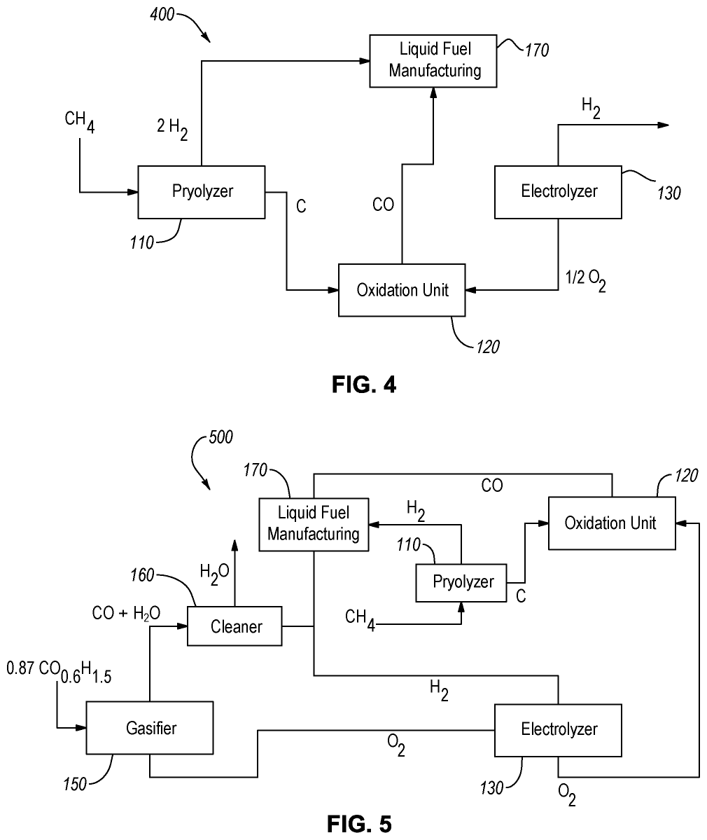

FIG. 4 is a block diagram of a system 400 for producing liquid fuel products, according to an embodiment. The liquid fuel manufacturing system in the system 400 uses the hydrogen from a pyrolyzer and carbon monoxide from a partial oxidation unit or system to form liquid fuel. The system 200 includes pyrolyzer 110, electrolyzer 130, an oxidation unit 120, and liquid fuel manufacturing system 170.

The pyrolyzer 110 is fluidly connected to a methane-containing gas source on an inlet or feed side thereof. The hydrogen product output of the pyrolyzer 110 is fluidly connected to the liquid fuel manufacturing system 170. The elemental carbon output of the pyrolyzer 110 is connected to the input for the oxidation unit 120. The oxygen output of the electrolyzer 130 is connected to the oxidation unit 120.

The oxidation unit 120 may at least partially oxidize the elemental carbon in the presence of oxygen from the electrolyzer 130 to form carbon monoxide. The formation of carbon monoxide in the oxidation unit 120 may be carried out at a selected rate to provide a selected ratio with the hydrogen input from the pyrolyzer 110. Control of the rate may be achieved by controlling the rate of elemental carbon fed from the pyrolyzer 110 and the rate of oxygen fed from the electrolyzer 130.

The oxygen output of the electrolyzer 130 may be fluidly connected to the oxidation unit 120. The hydrogen output of the electrolyzer 130 may be directed outside of the system 400.

While FIG. 4 is a block diagram of the system 400 for producing hydrogen and CO, to make liquid fuel, FIG. 4 can be viewed as a method for producing oxygen via electrolysis, carbon and hydrogen from pyrolysis, and CO from an oxidation unit to make liquid fuel. For example, pyrolyzing methane-containing gas may be carried out to produce carbon and hydrogen. Electrolysis may be carried out to produce oxygen gas for use in the oxidation unit. The carbon from the pyrolysis may be at least partially oxidized in the oxidation unit 120 using the oxygen from the electrolysis to create carbon monoxide. The carbon monoxide from the oxidation unit 120 may be fed into to the liquid fuel manufacturing system 170 along with hydrogen from pyrolysis to create liquid fuel (e.g., via FT reaction, methanol synthesis, or the like) or a chemical.

In the system 400, the pyrolyzer 110 makes hydrogen and hot elemental carbon. The carbon can be reacted with the oxygen produced by the electrolyzer 130. The system 400 may use substantially all the oxygen and all the carbon input into the system. For example, the hot carbon (from pyrolysis) is partially combusted to CO in the oxidation unit 120 using the oxygen (from electrolysis). The hydrogen from the pyrolysis is substantially entirely used in the liquid fuel manufacturing system 170. The hydrogen produced by the electrolyzer can be shipped out of the system (e.g., sold) or used to run a gas engine (not shown).

The approach shown FIG. 4 hydrogen rich (e.g., excess hydrogen is produced), while the approach shown in FIG. 2 is hydrogen deficient. Thus, it may be useful to combine the two systems 200 and 400 into a pyrolyzer-electrolyzer-gasifier system. such a system could be run in several modes.

FIG. 5 is a block diagram of system 500 for liquid fuel production, according to an embodiment. The system 500 includes pyrolyzer 110, electrolyzer 130, gasifier 150, cleaner 160, oxidation unit 120, and liquid fuel manufacturing system 170. The pyrolyzer 110 is connected to a methane-containing gas supply. The hydrogen output of the pyrolyzer 110 is connected to the liquid fuel manufacturing system 170 and the carbon output of the pyrolyzer 110 is connected to the oxidation unit 120. The electrolyzer 130 is connected to a supply of water. The oxygen output of the electrolyzer 130 is connected to the oxidation unit 120 and the gasifier 150. The hydrogen output of the electrolyzer 130 is connected to the liquid fuel manufacturing system 170. The gasifier 150 is connected to a feedstock source (e.g., biomass supply, coal, oil, natural gas, waste gas supply, well gas supply) to supply organic material to the gasifier 150. The gasifier 150 receives the feedstock and oxygen and gasifies the feedstock to produce carbon monoxide and water. An output side of the gasifier 150 is connected to the cleaner 160. The carbon monoxide and water are output to the cleaner 160 to separate the water from the carbon monoxide. A carbon monoxide output of the cleaner 160 is connected to the liquid fuel manufacturing system 170. A water output of the cleaner 160 is directed outside of the system 500. The carbon monoxide is fed from the cleaner 160 to the liquid fuel manufacturing system 170. Carbon from the pyrolyzer 110 and oxygen from the electrolyzer 130 are directed to the oxidation unit 120. The oxidation unit 120 at least partially oxidizes the carbon to produce carbon monoxide. The carbon monoxide output of the oxidation unit 120 is connected to the liquid fuel manufacturing system 170. The liquid fuel manufacturing system 170 uses the carbon monoxide from the oxidation unit 120 and gasifier 150 (via the cleaner 160) along with the hydrogen from the electrolyzer 130 and pyrolyzer 110 to produce liquid fuel. Hydrogen produced in the gasifier 150 may be used in the liquid fuel manufacturing system 170 (via the cleaner 160). The liquid fuel manufacturing system 170 is equipped to produce one or more of any of the fuels or chemicals disclosed herein, such as methanol, ethanol, FT diesel, gasoline, or the like.

An advantage of the system of FIG. 5 is that the electrolyzer 130 and the pyrolyzer 110 provide quick response. Their quick response can be used to adjust transients in the gasifier 150, that take substantially longer times to equilibrate. The net output of the system 500 is liquid fuels, and all the intermediate products are used, with the exception of a limited amount of water.

While FIG. 5 is a block diagram of the system 500 for producing hydrogen and CO, to make liquid fuel, FIG. 5 can be viewed as a method for producing oxygen and hydrogen via electrolysis, carbon and hydrogen from pyrolysis, and CO from a gasifier and an oxidation unit to make liquid fuel. For example, pyrolyzing methane-containing gas may be carried out to produce carbon and hydrogen. Electrolysis may be carried out to produce oxygen gas for use in the oxidation unit. The carbon from the pyrolysis may be at least partially oxidized in the oxidation unit 120 using the oxygen from the electrolysis to create carbon monoxide. The gasifier 150 gasifies the feedstock (0.87CO_{0.6}H_{1.5}) to produce carbon monoxide and water. The carbon monoxide produced in the gasifier 150 may be separated from the water produced in the gasifier 150 using the cleaner 160. The carbon monoxide from the gasifier 150 and the oxidation unit 120 may be fed into to the liquid fuel manufacturing system 170 along with hydrogen from pyrolysis and electrolysis to create liquid fuel. The liquid fuel may be produced using an FT reaction, methanol synthesis, ethanol synthesis, refining, or the like.

FIG. 5 shows a possible approach to produce liquid fuel or chemical. Under one approach, the individual stoichiometric units of reactants are matched, and there is no left over oxygen nor excess hydrogen in producing a liquid fuel from biomass.

Another approach is to operate the system in FIG. 1B in combination with a gasifier and liquid fuel manufacturing system.

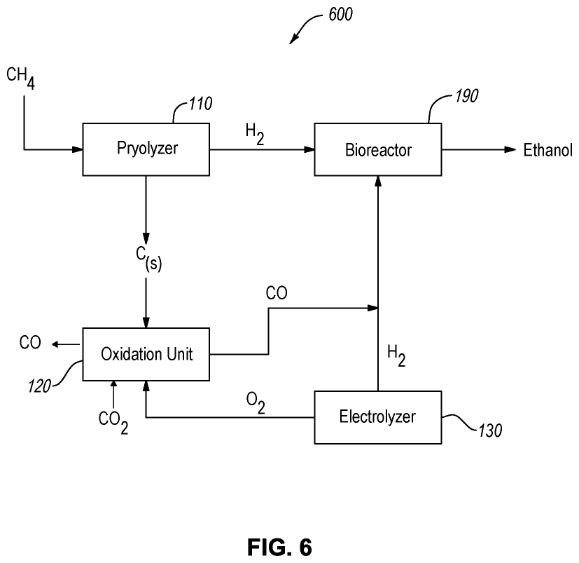

Another approach is to use of pyrolysis and electrolyzer in combination with a bio-reactor for liquid fuel manufacturing that produces a liquid fuel from methane-containing gas such as one or more of natural gas, renewable natural gas, or landfill gas. FIG. 6 is a block diagram of a system 600 for producing liquid fuel, according to an embodiment. The system 600 includes pyrolyzer 110, bioreactor 190, electrolyzer 130, and oxidation unit 120. The pyrolyzer 110 receives a feed stream (e.g., natural gas, landfill gas, or the like) and pyrolyzes the same to produce hydrogen gas and carbon. The hydrogen product output of the pyrolyzer 110 is connected to the bioreactor 190 and the carbon product output of the pyrolyzer 110 is connected to the oxidation unit 120.

The electrolyzer 130 produces oxygen and hydrogen from water. The oxygen output of the pyrolyzer 110 is connected to the oxidation unit 120 and the hydrogen output of the electrolyzer 130 is connected to the bioreactor 190. The oxidation unit 120 receives carbon from the pyrolyzer 110 and oxygen from the electrolyzer 130. The oxidation unit 120 (e.g., thermal oxidizer) oxidizes the carbon to produce carbon monoxide.

In some examples, the oxidation unit 120 is operably coupled to a carbon dioxide source to provide carbon dioxide for use in oxidizing the elemental carbon to produce carbon monoxide. The carbon dioxide may be used in place of or in addition to oxygen in the oxidation unit 120. In such examples, carbon monoxide may be output from the system 600 in addition to or in place of outputting carbon monoxide to the bioreactor 190.

The output of the oxidation unit 120 is connected to the bioreactor 190. The bioreactor uses a biological process to convert hydrogen and CO into a liquid fuel. The bioreactor 190 may include a stirred-tank bioreactor, a bubble column bioreactor, and airlift bioreactor, a fixed bed bioreactor, or the like. The carbon monoxide from the oxidation unit 120 is directed to the bioreactor 190 and hydrogen from the pyrolyzer 110 and electrolyzer 130 is directed to the bioreactor 190. In the bioreactor 190, the carbon monoxide and hydrogen are converted into a liquid fuel or chemical, such as ethanol or the like.

While FIG. 6 is a block diagram of the system 600 for producing hydrogen and CO, to make liquid fuel, FIG. 6 can be viewed as a method for producing oxygen and hydrogen via electrolysis, carbon and hydrogen from pyrolysis, and CO from an oxidation unit to make liquid fuel in a bioreactor. For example, pyrolyzing methane-containing gas may be carried out to produce (hot) carbon and hydrogen. Electrolysis may be carried out to produce oxygen gas for use in the oxidation unit. The carbon can be reacted with the oxygen produced by the electrolyzer. For example, carbon from the pyrolysis may be at least partially oxidized (e.g., combusted) in the oxidation unit 120 (e.g., thermal oxidizer) using the oxygen from the electrolysis to create carbon monoxide. The bioreactor 190 receives the hydrogen from the pyrolyzer and the carbon monoxide from the oxidation unit 120. The hydrogen from the electrolyzer 130 is fed into to the bioreactor 190 to create liquid fuel.

The system 600 and method depicted in FIG. 6 ideally uses all the oxygen and all the carbon in the system 600. The hydrogen from the pyrolyzer and electrolyzer is entirely used in the bioreactor to create liquid fuel, such as ethanol. The balancing of the needs for and the production of hydrogen and oxygen is dependent on the particular overall systems. Supplemental oxygen for achieving the balance can be provided by an air separation device included in any of the systems disclosed herein.

The ratio of reactants in the systems and methods disclosed herein may be adjusted for efficiency. For example, a ratio of hydrogen to carbon monoxide input into a liquid fuel manufacturing system may be at least 2:1 to efficiently create liquid fuel without creating waste in the system, aside from some output H₂O. Likewise, many of the components or processes disclosed herein may be performed using renewable electricity such as solar power, hydroelectric power, wind power, or the like. For example, pyrolysis and electrolysis may be carried out using at least some renewable electricity. Energy or resources from one component or process may be utilized to drive other processes in the systems and methods disclosed herein. For example, heat from combustion of one or more products may be utilized in pyrolysis or production of electricity. The electrical heating requirement of a pyrolyzer may be reduced by utilizing heat from combustion in the oxidation unit 120. Likewise, hydrogen produced in some of the systems and methods disclosed herein may be used to fuel a gas engine (e.g., gas turbine or reciprocating engine) to produce electricity.

At least some of the hydrogen produced in the systems and methods disclosed herein may be stored or sold for use off-site. In some examples, hydrogen produced from electrolysis and pyrolysis may be sold or stored separately or may be stored or sold as a mixture.

As used herein, the term “about” or “substantially” refers to an allowable variance of the term modified by “about” by ±10% or ±5%. Further, the terms “less than,” “or less,” “greater than”, “more than,” or “or more” include as an endpoint, the value that is modified by the terms “less than,” “or less,” “greater than,” “more than,” or “or more.”

While various aspects and embodiments have been disclosed herein, other aspects and embodiments are contemplated. The various aspects and embodiments disclosed herein are for purposes of illustration and are not intended to be limiting. Additionally, the words “including,” “having,” and variants thereof (e.g., “includes” and “has”) as used herein, including the claims, shall be open ended and have the same meaning as the word “comprising” and variants thereof (e.g., “comprise” and “comprises”).

1. A system for producing hydrogen and carbon monoxide, the system comprising:
a pyrolyzer operably coupled to a feed supply of a methane-containing gas, wherein the pyrolyzer is configured to convert methane from the methane-containing gas into hydrogen and elemental carbon via pyrolysis;
an electrolyzer configured to produce hydrogen and oxygen; and
an oxidation unit configured to produce one or more of carbon monoxide or carbon dioxide from the elemental carbon produced from the pyrolyzer and the oxygen produced from the electrolyzer.

2. The system of claim 1 wherein the pyrolyzer is configured to be heated using one or more of:
electrical heating including one or more of inductive heating, microwave heating, plasma heating, or joule heating;
heat from the oxidation unit; or
heat from burning hydrogen.

3. The system of claim 2 wherein the oxidation unit is configured to provide one or more of heat for operation of the pyrolyzer or to produce electricity for operation of the pyrolyzer and the oxidation unit includes a steam turbine, reciprocating gas engine, or gas turbine.

4. The system of claim 1 wherein at least one of the pyrolyzer or electrolyzer is electrically connected to one or more of a wind power or solar power source to provide electricity for producing heat in the pyrolyzer or electrolysis in the electrolyzer.

5. The system of claim 1 wherein a hydrogen output of the pyrolyzer is connected to a first outlet from the system and a hydrogen output of the electrolyzer is connected to a second outlet from the system.

6. The system of claim 1, further comprising a water-gas shift reactor connected to the hydrogen and carbon monoxide output of the pyrolyzer, wherein the water-gas shift reactor is configured to produce hydrogen and carbon dioxide.

7. The system of claim 6, wherein a hydrogen outlet of the water-gas shift reactor is connected to a gas engine configured to use the hydrogen produced from the water-gas shift reactor as fuel.

8. The system of claim 1 wherein the oxidation unit is coupled to a carbon dioxide source to feed carbon dioxide into the oxidation unit to increase production of carbon monoxide therein.

9.-19. (canceled)

20. A method for producing hydrogen, carbon monoxide, and carbon dioxide, the method comprising:
pyrolyzing a methane-containing gas to produce hydrogen and elemental carbon from pyrolysis;
electrolyzing water to produce hydrogen gas and oxygen from electrolysis; and
oxidizing the elemental carbon using the oxygen from the electrolyzer, carbon dioxide, or a combination thereof to produce carbon dioxide.

21. The method of claim 20 wherein electricity is used to provide heat for pyrolyzing the methane-containing gas via one or more of inductive heating, microwave heating, plasma heating, or joule heating.

22. The method of claim 21 wherein the electricity is supplied by one or more of solar power or wind power.

23. The method of claim 20, further comprising outputting hydrogen gas from pyrolysis and electrolysis as a mixture or separately for sale.

24. The method of claim 20 wherein the methane-containing gas includes natural gas or renewable natural gas.

25. A method for producing hydrogen, elemental carbon, carbon monoxide, and electricity, the method comprising:
electrolyzing water to produce hydrogen gas and oxygen from electrolysis;
pyrolyzing a methane-containing gas in the presence of oxygen from electrolysis to produce hydrogen, elemental carbon, and carbon monoxide from pyrolysis;
performing a water-gas shift reaction with the hydrogen and carbon monoxide from pyrolysis to produce hydrogen gas and carbon dioxide; and
oxidizing the hydrogen gas from the water-gas shift reaction in a gas engine to produce electricity.

26. The method of claim 25 wherein at least one of electrolyzing water or pyrolyzing methane-containing gas includes using electricity from solar power or wind power.

27. The method of claim 25 wherein electricity is used to provide heat for pyrolyzing the methane-containing gas via one or more of inductive heating, microwave heating, plasma heating, or joule heating.

28. The method of claim 25 wherein pyrolyzing methane-containing gas in the presence of oxygen from electrolysis to produce hydrogen, elemental carbon, and carbon monoxide from pyrolysis includes using a carbon to oxygen ratio of carbon in the methane-containing gas to oxygen of at least 2.

29. (canceled)

30. The method of claim 25, further comprising storing at least some of the oxygen produced by electrolysis prior to use in pyrolyzing the methane-containing gas in the presence of the oxygen.

31. The method of claim 25 wherein pyrolyzing methane-containing gas includes using electricity to heat the methane-containing gas to perform pyrolysis.

32. (canceled)

33. The method of claim 31, further comprising lowering a carbon to oxygen ratio of the methane-containing gas and oxygen used for pyrolysis as electricity is increased during pyrolysis.

34.-49. (canceled)
